(19) United States
(12) Patent Application Publication
(10) Pub. No.: US 2025/0068028 A1
(43) Pub. Date: Feb. 27, 2025

(54) DISPLAY DEVICE AND DISPLAY OPTICAL COMPONENT

(71) Applicant: DENSO CORPORATION, Kariya-city (JP)

(72) Inventors: Shinsuke HISATSUGU, Kariya-city (JP); Masato ISHII, Kariya-city (JP); Atsushi HIRAKAWA, Kariya-city (JP)

(21) Appl. No.: 18/943,494

(22) Filed: Nov. 11, 2024

Related U.S. Application Data
(63) Continuation of application No. PCT/JP2023/017909, filed on May 12, 2023.

(30) Foreign Application Priority Data
May 27, 2022 (JP) 2022-086853

(51) Int. Cl. G02F 1/29; B32B 7/02; B32B 27/08; B32B 27/30; B32B 27/36; B60K 35/22; G02B 27/00

(52) U.S. Cl. CPC G02F 1/291; B32B 7/02; B32B 27/08; B32B 27/308; B32B 27/365; B60K 35/22; G02B 27/0093; B32B 2255/10; B32B 2255/205; B32B 2307/412; B32B 2307/416; B32B 2307/7376; B32B 2457/20; B60K 2360/21; B60K 2360/741

(57) ABSTRACT

A display device includes: a plurality of display units; a display optical component that is placed to direct display light from the display units toward the viewer area, and has a plurality of layers. The total numerical number of the display optical component is one. The plurality of layers include: a base material layer; an optical function-applying layer that applies an optical function to the display optical component; and a balancer layer that balances stress with stress at a position close to the optical function-applying layer, wherein the balancer layer and the optical function-applying layer sandwich the base material layer.

### CROSS REFERENCE TO RELATED APPLICATIONS

The present application is a continuation application of International Patent Application No. PCT/JP2023/017909 filed on May 12, 2023, which designated the U.S. and claims the benefit of priority from Japanese Patent Application No. 2022-086853 filed on May 27, 2022. The entire disclosures of all of the above applications are incorporated herein by reference.

### TECHNICAL FIELD

The present disclosure relates to display technology.

### BACKGROUND

As a comparative example, a display optical component called a reflecting mirror and a display device using the component have been known. The reflecting mirror is constructed by laminating a base material layer and an optical function-applying layer called a mirror coat layer.

### SUMMARY

A display device includes: a plurality of display units; a display optical component that is placed to direct display light from the display units toward the viewer area, and has a plurality of layers. The total numerical number of the display optical component is one. The plurality of layers include: a base material layer; an optical function-applying layer that applies an optical function to the display optical component; and a balancer layer that balances stress with stress at a position close to the optical function-applying layer, wherein the balancer layer and the optical function-applying layer sandwich the base material layer.

### BRIEF DESCRIPTION OF THE DRAWINGS

FIG. 1 is a diagram showing a state where a display device is mounted on a vehicle.

FIG. 2 is a cross-sectional view taken along a line Il-Il in FIG. 1.

FIG. 3 is a diagram showing a schematic configuration of a display device and a control device.

FIG. 4 is an exploded view of a mirror plate.

FIG. 5 is a cross-sectional view of the mirror plate taken along a line V-V in FIG. 2.

FIG. 6 is an enlarged view of a portion VI in FIG. 5, showing an example of a configuration of the mirror plate.

FIG. 7 is an enlarged view of a portion VII in FIG. 5, showing an example of the configuration of the mirror plate.

FIG. 8 is a diagram showing a schematic configuration of a driver monitor unit.

FIG. 9 is an exploded view of the mirror plate.

FIG. 10 is a view corresponding to FIG. 5 according to a second embodiment.

FIG. 11 is an enlarged cross-sectional view taken along a line XI-XI in FIG. 10.

FIG. 12 is an enlarged cross-sectional view taken along a line XII-XII in FIG. 10.

FIG. 13 is a diagram showing a content display example from a driver seat viewpoint.

FIG. 14 is a diagram showing a content display example from a passenger seat viewpoint.

FIG. 15 is a diagram for illustrating switching of lighting.

FIG. 16 is a diagram showing an icon display example.

FIG. 17 is a diagram showing an icon display example.

FIG. 18 is a diagram showing an icon display example.

### DETAILED DESCRIPTION

However, in the comparative example, when heat is applied to the reflecting mirror, differences in shrinkage among layers and the like can make it difficult to maintain the originally intended shape or structure. There is concern that, due to changes in shape or structure, it is not possible to maintain the required display quality.

One example of the disclosure provides a display optical component capable of implementing the quality that can be required in display, and a display device including the component.

According to one example embodiment, a display device performs display toward a viewer area, and the display device includes: a plurality of display units that emit display light; a display optical component that is provided for the plurality of display units and placed to direct the display light from each of the display units toward the viewer area, and has a plurality of layers in a lamination state, wherein a total numerical number of the display optical component provided for the plurality of display units is one. The plurality of layers include: a base material layer; an optical function-applying layer that has a thermal dimensional change characteristic that more easily contracts than the base material layer and applies an optical function to the display optical component; and a balancer layer that has a thermal dimensional change characteristic closer to the optical function-applying layer than the base material layer so as to balance stress with stress at a position close to the optical function-applying layer, wherein the balancer layer and the optical function-applying layer sandwich the base material layer.

According to another example embodiment, a display optical component is used for display, and the display optical component includes a plurality of layers in a lamination state, the plurality of layers include: a base material layer; an optical function-applying layer that has a thermal dimensional change characteristic that more easily contracts than the base material layer and applies an optical function; and a balancer layer that has a thermal dimensional change characteristic closer to the optical function-applying layer than the base material layer so as to balance stress with stress at a position close to the optical function-applying layer, wherein the balancer layer and the optical function-applying layer sandwich the base material layer.

According to these example embodiments, in the display optical component including multiple lamination layers, the balancer layer is placed at the opposite position to the optical function-applying layer with respect to the base material layer. The balancer layer balances the stress with components close to the optical function-applying layer. Therefore, even when the optical function-applying layer has a thermal dimensional change characteristic that makes it more likely to be contracted than the base material layer, a balanced stress can be obtained on both sides of the base material layer when heated. Therefore, the shape and structure of the display optical components are more likely to be maintained. Therefore, it is possible to implement the required quality in the display.

Hereinafter, multiple embodiments will be described with reference to the drawings. It is noted that the same reference numerals are attached to the corresponding constituent elements in each embodiment, and redundant explanation may be omitted. In each of the embodiments, when only a part of the configuration is described, the remaining parts of the configuration may adopt corresponding parts of other embodiments. Further, not only the combinations of the configurations explicitly shown in the description of the respective embodiments, but also the configurations of the plurality of embodiments can be partially combined even when they are not explicitly shown as long as there is no difficulty in the combination in particular.

### First Embodiment

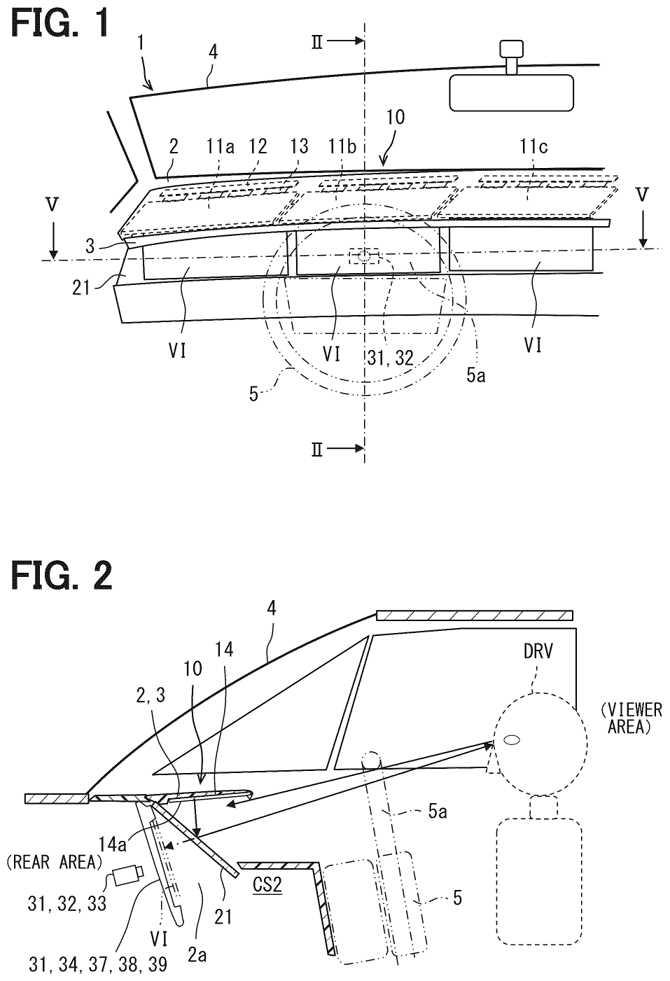

A display device 10 according to a first embodiment of the present disclosure is mounted on a vehicle 1 as shown in FIGS. 1 to 3. The display device 10 is installed on an instrument panel 2 that faces, in a front-rear direction of the vehicle 1, a seat on which an occupant (including a driver DRV) as a viewer is seated.

The instrument panel 2 shown in FIGS. 1 and 2 is provided with a housing room 2a for housing a display device 10. The housing room 2a is formed so as to extend in a left-right direction of the vehicle 1 from a portion facing the driver seat toward a portion facing the passenger seat.

A visor hood 3 is provided on the ceiling of the housing room 2a. The visor hood 3 is formed of, for example, a synthetic resin having a light blocking property. The visor hood 3 is formed so as to extend in a straight line over the entire left-right direction of the vehicle 1 from a left A-pillar to a right A-pillar of the vehicle 1. The visor hood 3 prevents external light entering the vehicle interior through a front windshield 4 or the like from reducing the visibility of the display on the display device 10. Therefore, a rear end of the visor hood 3 is formed so as to protrude in the front-rear direction of the vehicle 1 from the lower end of the front windshield 4 to a position closer to the driver seat than the display device 10.

Further, the visor hood 3 has a recess formed on a lower surface thereof facing the lower of the vehicle 1 so that a display panel 14 (described later) can be fitted therein. In this way, the visor hood 3 also functions as a case that houses the housing of the display device 10.

A steering wheel 5 is held at a position corresponding to the lower portion of the housing room 2a. The upper portion of the steering wheel 5 is located between the display device 10 and the headrest of the driver seat. The steering wheel 5 constitutes an operation portion of a steering system that steers the vehicle 1, and the operation portion is operated by the driver DRV seated in the driver seat. The steering wheel 5 has an annular rim portion and a connection portion that connects the rim portion to a steering shaft. The connection portion has a center pad portion disposed on the axis of the steering shaft, and a spoke portion extending radially toward the rim portion to connect the center pad portion and the rim portion.

The steering wheel 5 has an opening 5a that is surrounded by the rim portion and the connection portion. The opening 5a is located at the upper portion of the steering wheel 5 when the steering wheel 5 is in a normal attitude (i.e., an attitude corresponding to a steering wheel angle at which the vehicle 1 moves straight). Thereby, the driver DRV is possible to view the display on the display device 10 that is located in front of the driver seat through the opening 5a.

The display device 10 of the present embodiment is capable of displaying a virtual image to multiple occupants including the driver DRV seated in the driver seat and an occupant seated in the passenger seat. Here, a position close to the driver seat and the passenger seat with respect to the display device 10 is defined as a viewing position. The display device 10 includes multiple image display units 11a to 11e, a mirror plate 21, a rear unit 31, and the like.

The image display units 11a to 11e are held by the visor hood 3 as described above. The multiple image display units 11a to 11e are arranged in a line across from the left A-pillar to the right A-pillar of the vehicle 1.

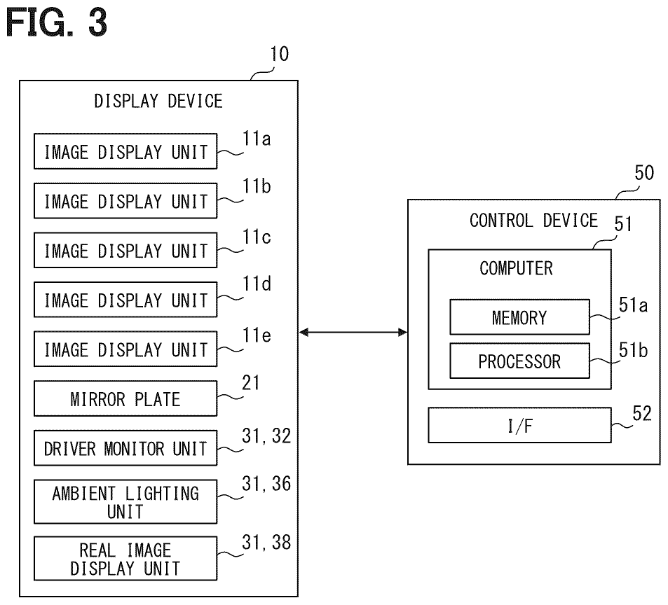

Each of the image display units 11a to 11e includes a circuit board 12, a flexible wiring board 13, the display panel 14, and the like. As shown in FIG. 1, the circuit board 12 is formed in a flat plate shape from synthetic resin such as glass epoxy resin. The circuit board 12 has a conductive pattern formed on at least one surface. The circuit board 12 is provided with a control circuit that is configured with multiple electronic components and conductive patterns. The control circuit is capable of communicating with a control device 50 (see FIG. 3) via wired or wireless communication, and is capable of controlling the display panel 14 based on an input signal from the control device 50.

The control device 50 may be provided inside the display device 10 and may have a coordination function for controlling the multiple image display units 11a to 11 e to coordinate with each other. On the other hand, the control device 50 may be an in-vehicle ECU or the like provided outside the display device 10.

The flexible wiring board 13 is formed by attaching a thin film seal having a conductive pattern formed thereon to a base film made of, for example, polyimide or the like. One end of the flexible wiring board 13 is electrically connected to the circuit board 12. The other end of the flexible wiring board 13 is electrically connected to the display panel 14.

The display panel 14 is, for example, an OLED display, a liquid crystal display, or the like, and has a panel shape. As shown in FIG. 2, the display panel 14 has a flat display screen 14a facing downward of the vehicle 1, which is opposite to the visor hood 3. The display screen 14a has a rectangular outer shape with pixels arranged in longitudinal and lateral directions. The display state of each pixel is controlled by the control circuit, so that the display screen 14a can emit light and display an image downward. The display screen 14a is capable of displaying color images, but may also be capable of displaying monochrome or single-color images.

For example, five image display units 11a to 11e may be provided. The display screens 14a of the image display units 11a to 11e may be arranged along a common imaginary plane. In this arrangement, virtual images VI that can be displayed by the image display units 11a to 11e are formed at successive positions. Therefore, it is possible to improve the sense of unity of the entire display. On the other hand, the display screens 14a may be arranged so as to form a step with respect to each other. In this arrangement, the virtual images VI that can be displayed by the image display units 11a to 11e are formed at different positions from one another in the front-rear direction. Therefore, it is possible to apply a three-dimensional effect to the entire display.

When the vehicle 1 is a left steering wheel vehicle, of the five image display units 11a to 11 e, the second image display unit 11b counting from the left may perform display in front of the driver seat. That is, the second image display unit 11b from the left may display the virtual image VI that is viewed through the opening 5a of the steering wheel 5.

The contents displayed by each image display unit 11a to 11e in a left steering wheel vehicle may be based on the allocation shown below, for example. The content by the first image display unit 11a from the left may be so-called electronic mirror content that displays an image captured by a left rear camera that captures the left rear of the vehicle 1. The content displayed by the second image display unit 11b from the left may be so-called meter content that displays various travel information (for example, travel speed, travel mode, travel distance, remaining battery power, etc.) of the vehicle 1. The content displayed by the third image display unit 11c from the left may be so-called navigation content that displays navigation information (for example, images guiding the current location of the vehicle 1 and the route to the destination, road information, etc.). The content displayed by the fourth image display unit 11d from the left may be entertainment video or content that displays information about an in-vehicle air conditioner. The content displayed by the fifth image display unit 11e counting from the left may be so-called electronic mirror content that displays an image captured by a right rear camera that captures the right rear of the vehicle 1.

In a case where the vehicle 1 is a right steering wheel vehicle, the contents inverted in order from the case where the vehicle 1 is the left steering wheel vehicle described above may be allocated to each image display unit. Further, the content allocation may be changeable to the occupant preference based on, for example, a setting operation performed by the occupant.

The mirror plate 21 is an optical component formed in the shape of a light-transmitting plate using a synthetic resin such as an acrylic resin. The mirror plate 21 placed so as to face the visor hood 3 and each display screen 14a. The mirror plate 21 is inclined from the upper portion of the vehicle toward the lower position of the vehicle, and the lower portion is closer to the driver seat.

The mirror plate 21 is formed so as to extend across the entire left-right direction of the vehicle 1 from the left A-pillar to the right A-pillar of the vehicle 1, for example, similar to the visor hood 3. That is, one mirror plate 21 is provided for each of the image display units 11a to 11e. Providing multiple image display units 11a to 11e makes it possible to use the display panel 14 having a general aspect ratio. Further, by providing one mirror plate 21 that is directly visible to the occupants, it is possible to improve the sense of unity between the left and right pillars. On the other hand, as the mirror plate 21 becomes larger, measures against deformation, such as providing the balancer layer 25b as described below, become necessary.

The mirror plate 21 directs the display light emitted from each display screen 14a toward the viewer area. Specifically, the mirror plate 21 reflects display light emitted from each display screen 14a to the viewer area. The mirror plate 21 forms the virtual image VI that is visible to the driver DRV seated in the driver seat and the passenger seated in the passenger seat. The mirror plate 21 is placed between the formation position and at the driver seat and the passenger seat. The formation position may be regarded as an opposite side position to the seats, and the opposite side position may be defined as a rear side position. Here, the reflective surfaces of the mirror face each display screen as well as the driver seat and passenger seat, and reflect the display light. The reflective surfaces have a curved shape that makes it easy for the driver DRV sitting in the driver seat and the passenger sitting in the passenger seat to view the virtual image VI.

As shown in FIGS. 2, 4 and 5, for example, the curved shape of the reflective surface may be a concave cylindrical surface that is curved in a concave manner. More specifically, in a cross section CS1 of the mirror plate 21 along the left-right direction of the vehicle 1, the reflective surface is curved to form a gentle curve. The cross section CS1 may be said to be a cross section along the longitudinal direction of the mirror plate 21. The gentle curve here refers to a curve that implements a shape of the mirror plate 21 that enables the display device 10 to be housed in the housing room 2a. For example, a gentle curve is a curve formed so as to extend across the entire left-right direction of the vehicle 1, and the depth of the mirror plate 21 is smaller than the depth of the housing room 2a in the instrument panel 2. On the other hand, in a cross section CS2 of the mirror plate 21 that is perpendicular to the cross section CS1 and is aligned along the short side of the mirror plate 21, the reflective surface extends in a straight line.

Such a curved shape of the reflective surface improves the ease of mounting the mirror plate 21 on the vehicle 1 and the design when incorporated into the instrument panel 2. Furthermore, the virtual images VI are arranged consecutively so as to be placed on the curved surface that curves in the left-right direction. Due to the image formation positions of the virtual images VI, the virtual image display is directed toward the driver DRV seated in the driver seat and the passenger seated in the passenger seat so as to surround the driver and the passenger.

In particular, the mirror plate 21 of the present embodiment has optical transparency. The optical transparency referred to here may include at least one of the properties of transmitting visible light or transmitting near-infrared light. The property of transmitting visible light here may mean a property of transmitting light of all wavelengths within visible light, or a property of transmitting light of some wavelengths within visible light. By providing the mirror plate 21 with optical transparency, it is possible to add a function that utilizes light to the rear unit 31 placed at the rear area.

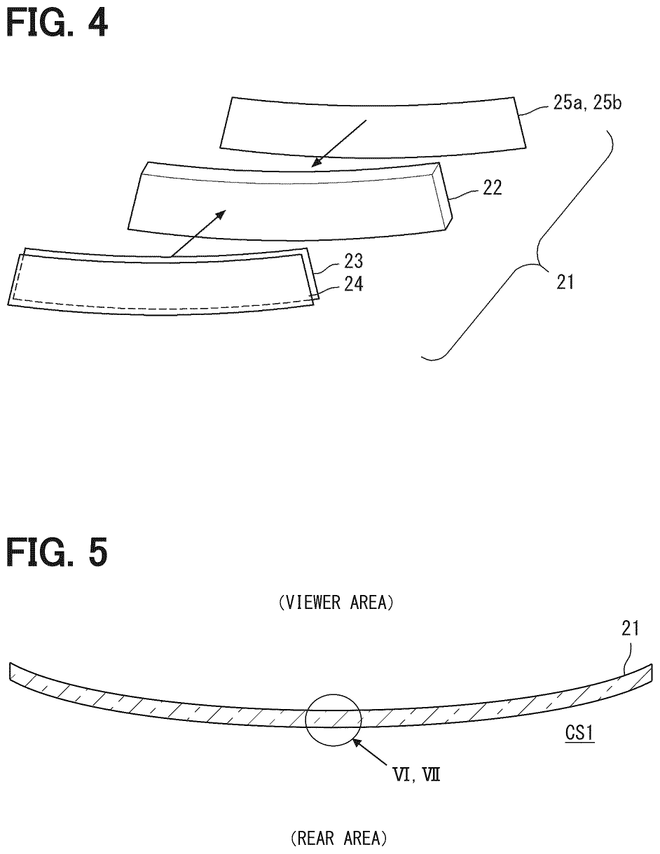

As shown in FIGS. 4 to 7, the mirror plate 21 has a plate-shaped portion formed of a structure including multiple layers in the lamination state. For example, the multiple layers include a base material layer 22, an optical function-applying layer 23, a protective layer 24, and a balancer layer 25a (25b).

The base material layer 22 is formed in a plate shape from a synthetic resin material having optical transparency, such as PMMA resin, PC resin, or the like. The base material layer 22 is formed by, for example, injection molding. The base material layer 22 ensures the basic strength of the mirror plate 21. The base material layer 22 may have a thickness of, for example, 1 to 5 mm. The base material layer 22 may be formed to be colorless and transparent, for example, with a visible light transmittance of 90% or more. The base material layer 22 may be formed in a smoky color with a visible light transmittance of, for example, 3 to 90%. In the present embodiment, the transmittance is an energy transmittance, and the reflectance is an energy reflectance.

The optical function-applying layer 23 is a layer that applies the optical function to the mirror plate 21. The optical function-applying layer 23 is placed closer to the viewer area than the base material layer 22. The function that the optical function-applying layer 23 applies to the mirror plate 21 is a reflecting function. The reflectance of the display light by the optical function-applying layer 23 is preferably set to, for example, 30% or more. As a result, the mirror plate 21 of the present embodiment can be recognized by the occupant as a half mirror.

The optical function-applying layer 23 that applies a reflective function may be a film or sheet material in which a metal thin film is deposited on a resin film by vapor deposition. The film or sheet material may be placed in an affixed relationship to the base material layer 22. The optical function-applying layer 23 that applies a reflective function may be an optical multi-layer film formed by multiple layers of inorganic compounds or metal oxides. The optical multilayer film may be formed in the form of, for example, a film material or a sheet material, and may be disposed in a state of being attached to the base material layer 22.

Such film or sheet materials are produced by a manufacturing method in which raw materials are rolled and stretched to form a thin film, and then wound into a roll. Therefore, the thickness of the optical function-applying layer 23 is set to be sufficiently smaller than the thickness of the base material layer 22.

Furthermore, as a result of the molecular chains being oriented in the direction of extension, residual stress remains inside the film or sheet material. Therefore, the optical function-applying layer 23 has a thermal dimensional change characteristic that makes it more likely to shrink than the base material layer 22. When heat is applied to the film or sheet material during the manufacture of the mirror plate 21, a change in residual stress may occur. Thereby, the film or sheet material may shrink and deform. This phenomenon can also occur when the interior of the vehicle becomes too hot, although not as hot as during manufacturing.

The thermal dimensional change property referred to here may be quantified by a value expressing the dimensional change (change in the distance between gauge lines in the longitudinal and lateral directions of the test piece) as a percentage of the initial distance between the gauge lengths, measured by a method for measuring thermal dimensional change of films and sheets described in JIS K7133:1999. According to this quantification, a negative value indicates a property of contracting due to heating, and a positive value indicates a property of expanding due to heating. When comparing values for two materials, the material with the smaller value has heat dimensional properties that tend to contract more readily than the material with the larger value. When the absolute difference between the values for two materials is small, then the two materials are said to have similar heated dimensional properties. In each embodiment of the present disclosure, the contents of JIS K7133:1999 are entirely incorporated by reference.

The protective layer 24 is a layer that constitutes the surface of the mirror plate 21 that is exposed to the outside. The protective layer 24 is placed closer to the viewer area than the optical function-applying layer 23. The protective layer 24 protects the optical function-applying layer 23. The thickness of the protective layer 24 is set to be sufficiently smaller than the thickness of the base material layer 22. The thickness of the protective layer 24 may be approximately the same as the thickness of the optical function-applying layer 23, or may be set to be greater than the thickness of the optical function-applying layer 23.

The protective layer 24 may be formed by dipping or printing a hard coat liquid. The protective layer 24 may be a film or sheet material having a PMMA film laminated thereon, and may be placed in a state of being attached to the optical function-applying layer 23. When the protective layer 24 is formed using a film material or a sheet material, the protective layer 24 has heat dimensional change characteristics that make it more likely to contract than the base material layer 22.

The balancer layer 25a (25b) is placed closer to the rear surface than the base material layer 22. The balancer layer 25a (25b) and the optical function-applying layer 23 sandwich the base material layer 22. The balancer layer 25a (25b) is a layer provided so as to balance the stress with the opposite position sandwiching the base material layer 22 with the balancer layer 25a (25b), that is, stress closer to the optical function-applying layer 23.

The stress may be balanced with the optical function-applying layer 23 alone. The stress balance may be achieved between the optical function-applying layer 23 and the protective layer 24, which are regarded as an integrated layer. In other words, depending on the configuration of the protective layer 24 and other layers other than the optical function-applying layer 23, it should be considered whether to take into account the residual stress of the protective layer 24 and other layers. By achieving the stress balance, it is possible to reduce the thickness of the base material layer in design and to reduce the weight of the mirror plate 21.

The balancer layer 25a (25b) may be formed in the form of a film or sheet material having the same or similar thermal dimensional change characteristics or residual stress characteristics as the optical function-applying layer 23, and may be placed in a state of being attached to the base material layer 22. That is, the thickness of the balancer layer 25a (25b) is set to be sufficiently smaller than the thickness of the base material layer 22. In addition, the balancer layer 25a (25b) has the thermal dimensional change characteristic that allows it to contract more easily than the base material layer 22. More specifically, the balancer layer 25a (25b) has thermal dimensional change characteristics closer to those of the optical function-applying layer 23 than to those of the base material layer 22.

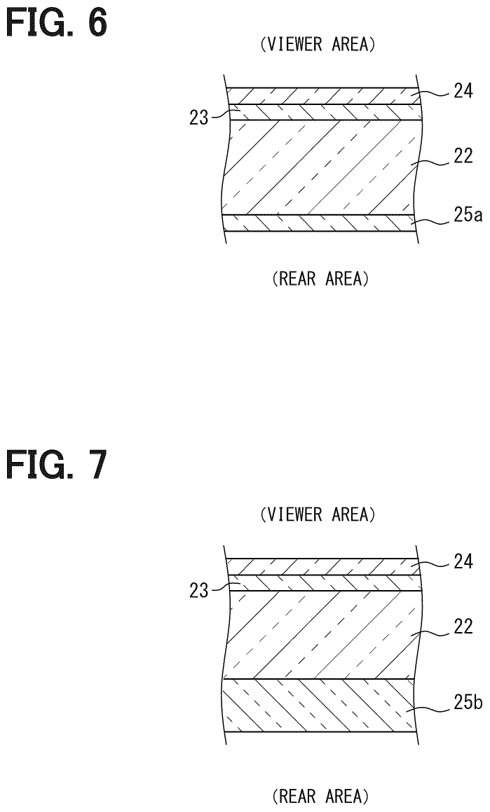

As shown in FIG. 6, in order to balance the stress, the balancer layer 25a may be made of substantially the same material as the optical function-applying layer 23. In order to reproduce residual stress equivalent to that of the optical function-applying layer 23, the balancer layer 25a may be subjected to substantially the same rolling and stretching loads as the optical function-applying layer 23 and formed to substantially the same thickness as the optical function-applying layer 23. The balancer layer 25a may be set to a thickness of, for example, 10 to 500 μm.

Also, as shown in FIG. 7, the balancer layer 25b may be made of a material different from the material constituting the optical function-applying layer 23 (for example, an inexpensive synthetic resin material having optical transparency such as PMMA resin, PC resin, or PET resin). In this case, the balancer layer 25b may be formed to have a thickness different from that of the optical function-applying layer 23 in order to achieve the residual stress equivalent to that of the optical function-applying layer 23.

Specifically, when the balancer layer 25b and the optical function-applying layer 23 have the same thickness, and the optical function-applying layer 23 has the larger residual stress, the thickness of the balancer layer 25b can be set to be greater than the thickness of the optical function-applying layer 23. When the balancer layer 25b and the optical function-applying layer 23 were to have the same thickness, the balancer layer 25b would have the larger residual stress, the thickness of the balancer layer 25b can be set to be smaller than the thickness of the optical function-applying layer 23.

As shown in FIG. 2, the rear unit 31 is placed close to the rear of the mirror plate 21 and spaced apart from the mirror plate 21. The rear unit 31 is a unit that adds a function that utilizes light to the display device 10. The rear unit 31 may be provided in one unit or in multiple units. As shown in FIG. 3, the rear unit 31 may include at least one of a driver monitor unit 32, an ambient lighting unit 36, or a real image display unit 38.

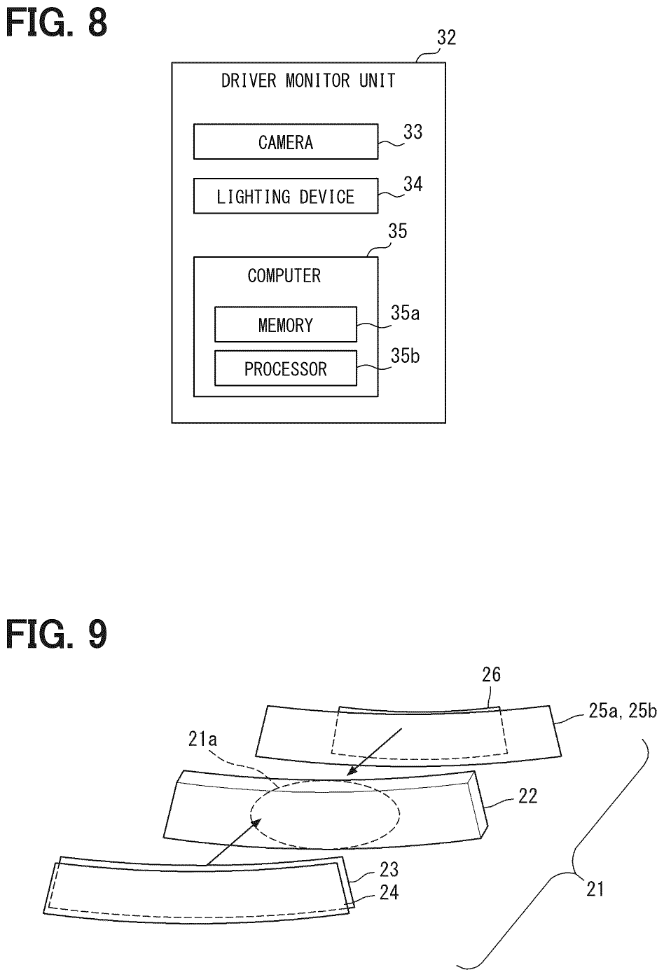

The driver monitor unit 32 is used in a driver monitor system that monitors the state of the driver DRV. The state of the driver DRV includes a drowsy state, a state of looking away, and the like. The driver monitor unit 32 includes a camera 33, a lighting device 34, and a dedicated computer 35, as shown in detail in FIG. 8. The camera 33 captures an image of the driver DRV by forming an image of near-infrared light, for example. The lighting device 34 is, for example, a near-infrared LED, and implements proper exposure in camera photography by emitting light toward the driver DRV. The light may be emitted continuously or in conjunction with the timing of photographing. The dedicated computer 35 controls the lighting device 34 and also processes the image data captured by the camera 33 to analyze the condition of the driver DRV.

The dedicated computer 35 has at least one memory 35a and one processor 35b. The memory 35a may be at least one type of non-transitory tangible storage medium, such as a semiconductor memory, a magnetic medium, an optical medium, and the like, which non-temporarily stores a program, data, and the like that can be read by the processor 35b. Furthermore, for example, a rewritable volatile storage medium such as a random access memory (RAM) may be provided as the memory 35a. The processor 35b includes, for example, at least one type of a central processing unit (CPU), a graphics processing unit (GPU), and a reduced instruction set computer (RISC)-CPU as a core.

As shown in FIGS. 2 and 3, the ambient lighting unit 36 provides a lighting effect from the rear side of the mirror plate 21, thereby improving the visibility and appearance of the display device 10. The ambient lighting unit 36 includes multiple light sources 37. The light source 37 is configured by an LED, an OLED, or the like, and is capable of emitting light in a single color or in multiple colors. The multiple light sources 37 may be designed to be switched between an on state and an off state simultaneously. The multiple light sources 37 may be individually controllable to switch between the on state and the off state.

The real image display unit 38 includes a display panel 39. The display panel 39 is, for example, an OLED display or a liquid crystal display, and is disposed with its display screen facing the driver's seat or the passenger's seat. The real image display unit 38 is capable of displaying real image content in cooperation with each of the image display units 11a to 11e that display the above-mentioned virtual image VI, or in a form that complements each of the image display units 11a to 11 e. The real image display unit 38 may also include a mechanical indicator.

The control device 50 shown in FIG. 3 controls the virtual image display by each of the image display units 11a to 11 e. The control device 50 may further control at least one of the lighting by the ambient lighting unit 36 or the real image display by the real image display unit 38 in the rear unit 31.

The control device 50 includes an interface 52 and a dedicated computer 51. The interface 52 includes at least one of a terminal and a communication device for communicating with an external control target via wired communication or wireless communication.

The dedicated computer 51 has at least one memory 51a and one processor 51b. The memory 51a may be at least one type of non-transitory tangible storage medium, such as a semiconductor memory, a magnetic medium, an optical medium, and the like, which non-temporarily stores a program, data, and the like that can be read by the processor 51b. Furthermore, for example, a rewritable volatile storage medium such as a random access memory (RAM) may be provided as the memory 51a. The processor 51b includes, for example, at least one type of a central processing unit (CPU), a graphics processing unit (GPU), and a reduced instruction set computer (RISC)-CPU as a core.

In the present embodiment, the image display units 11a to 11e correspond to a “display unit”. The real image display unit 38 may also correspond to the “display unit”. The mirror plate 21 corresponds to a “display optical component”. The driver monitor unit 32 corresponds to a “monitor unit”. The ambient lighting unit 36 corresponds to a “lighting unit”.

### (Operation and Effects)

Operation effects of the first embodiment as described above will be described below.

According to the first embodiment, in the mirror plate 21 having multiple lamination layers, the balancer layer 25a (25b) is placed at the opposite position to the optical function-applying layer 23 with respect to the base material layer 22. The balancer layer 25a (25b) balances the stress with components close to the optical function-applying layer 23. Therefore, even when the optical function-applying layer 23 has a thermal dimensional change characteristic that makes it more likely to contract than the base material layer 22, a balanced stress can be obtained on both sides of the base material layer 22 when heated. Therefore, the shape and structure of the mirror plate 21 are easily maintained. Accordingly, it is possible to implement the required quality in the display.

Furthermore, according to the first embodiment, even when the mirror plate 21 is optically transparent, the balancer layer 25a (25b) constitutes only one of multiple layers, so that it is possible to reduce deterioration in the appearance of the mirror plate 21.

Furthermore, according to the first embodiment, the balancer layer 25b is formed from a material different from that of the optical function-applying layer 23, and is formed to a thickness different from that of the optical function-applying layer 23. By adjusting the material and thickness in a complex manner, it is possible to easily balance the stress.

Furthermore, according to the first embodiment, the optical function-applying layer 23 applies a function of reflecting display light as an optical function, thereby forming the virtual image VI on the position close to the rear surface of the mirror plate 21. Thereby, it is possible to implement a novel display.

### Second Embodiment

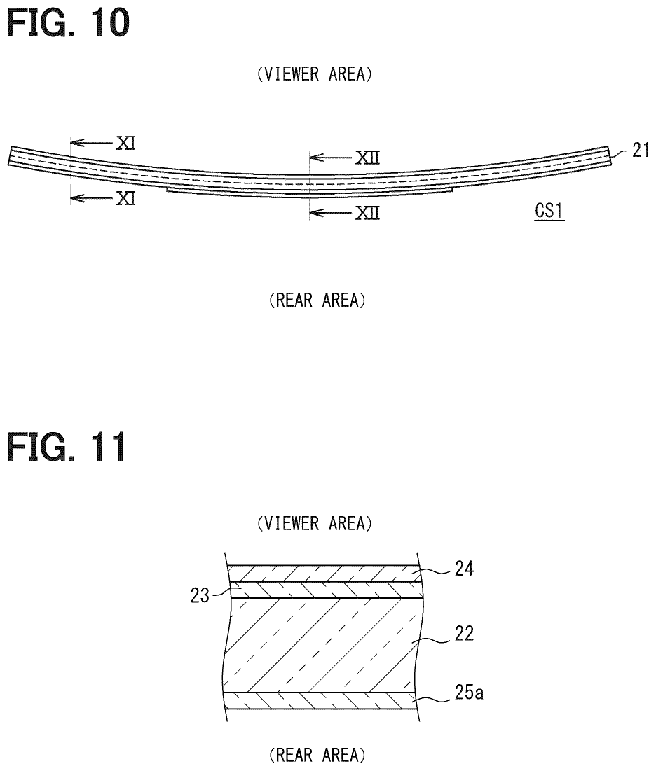

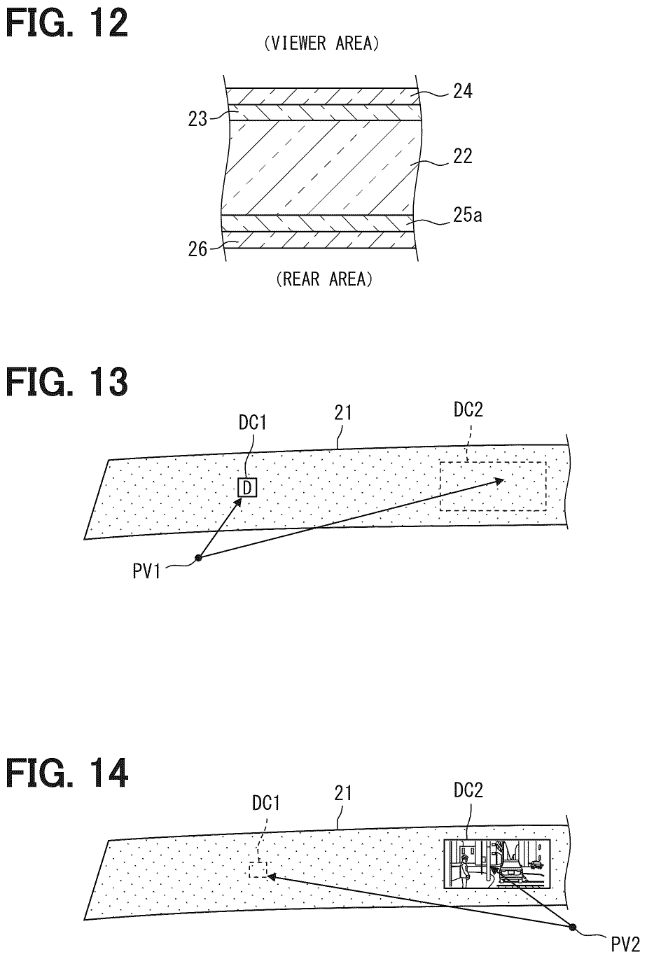

As shown in FIGS. 9 to 12, a second embodiment is a modification of the first embodiment. The second embodiment will be described with focus on its differences from the first embodiment.

In the second embodiment, the multiple layers further include an additional adjustment layer 26. The additional adjustment layer 26 is a layer that locally adjusts the stress balance. The additional adjustment layer 26 is placed at the opposite position to the optical function-applying layer 23 and the protective layer 24 with respect to the base material layer 22. The additional adjustment layer 26 is placed closer to the rear surface than balancer layer 25a, and is laminated on a part of the area formed by the surface of the balancer layer 25a.

The additional adjustment layer 26 may be formed in the form of a optical transparency film or sheet material, and may be placed in a state where it is attached to a partial area of the balancer layer 25a. Thereby, the total thickness of the balancer layer 25a and the additional adjustment layer 26 in a partial area of the balancer layer 25a becomes greater than the thickness in the other area. This partial area may be, for example, an area corresponding to a central portion 21a (or the inner peripheral portion) of the mirror plate 21.

In this manner, even when there are different potential tendencies in deformation due to thermal contraction between the central portion 21a and the end or between the inner and outer periphery of the optical function-applying layer 23 in a large-area mirror plate 21, the additional adjustment layer 26 realizes local adjustment. Therefore, it is possible to balance the stress on both sides of the base material layer 22 over the entire mirror plate 21.

### Third Embodiment

As shown in FIGS. 13 to 18, a third embodiment is a modification of the first embodiment. The third embodiment will be described mainly on configurations different from those of the first embodiment.

The balancer layer 25a of the third embodiment applies, to the mirror plate 21, a function different from that of the optical function-applying layer 23. The function different from that of the optical function-applying layer 23 may be an optical function or may be another function different from the optical function.

As an example of the function, a film material or sheet material having wavelength selective transparency is adopted for the balancer layer 25a. Thereby, the balancer layer 25a may apply, to the mirror plate 21, a wavelength selective transparency function of selecting and transmitting a wavelength.

The display device 10 may include both the balancer layer 25a having the property of transmitting near-infrared light wavelengths and not transmitting visible light, and the driver monitor unit 32 as the rear unit 31. In this way, the driver DRV cannot easily see the driver monitor unit 32, and deterioration in the appearance of the display device 10 is reduced, while the driver monitor unit 32 can monitor the state of the driver DRV.

As another example of the function, a film material or sheet material (for example, LCF, VCF) having a viewing angle control property or a polarizing property may be adopted for the balancer layer 25a. The display device 10 may include multiple real image display units 38 as the rear unit 31. In this configuration, the real image displayed by the real image display unit 38 can be selectively visualized for the driver seat and the passenger seat to present information.

For example, content necessary for the driver DRV to drive is displayed on the real image display unit 38 placed in front of the driver seat, and entertainment-related content is displayed on the real image display unit 38 placed in front of the passenger seat. By the balancer layer 25a restricting the light that passes through the surface of the mirror plate 21 in an oblique direction, as shown in FIG. 13, from a driver seat viewpoint PV1, the content necessary for driving can be viewed, while the entertainment-related content is difficult to be viewed. Also, as shown in FIG. 14, from a passenger seat viewpoint PV2, the entertainment content can be viewed, but the content necessary for driving is difficult to be viewed.

As another example of the function, the balancer layer 25a may be made of a decorative film or sheet material having optical transparency, so that the balancer layer 25a may apply a decorative function to the mirror plate 21. Then, the display device 10 may include the ambient lighting unit 36 as the rear unit 31. In this configuration, the atmosphere created by the display device 10 can be changed by switching the lighting by the ambient lighting unit 36 on and off.

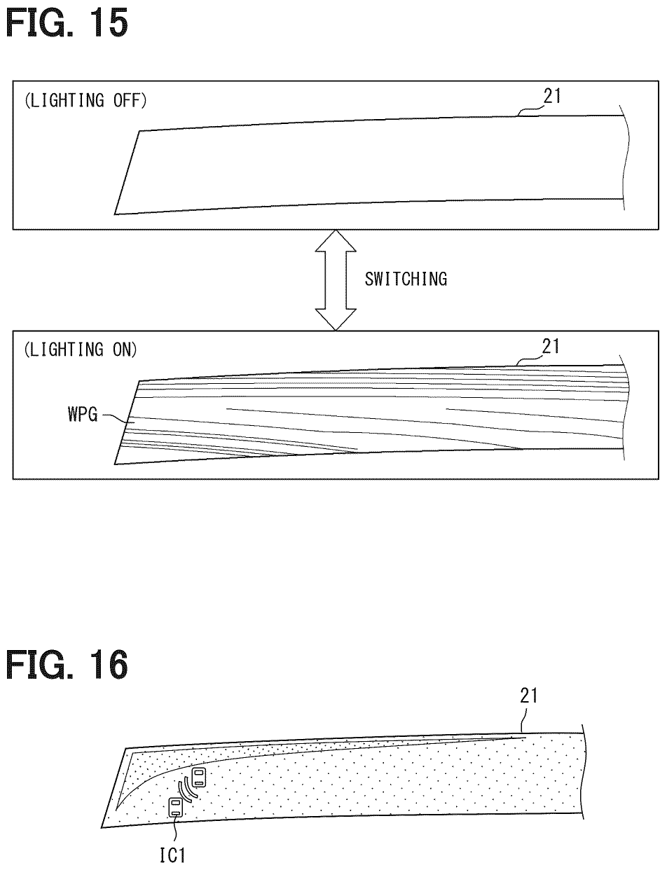

For example, as shown in FIG. 15, the decorative film material has a wood grain pattern WGP. Here, in the first state, when the illumination of the ambient lighting unit 36 is turned on, the wood grain pattern WGP appears to emerge from the mirror plate 21. Thereby, it is possible to create a sense of luxury for the instrument panel 2. On the other hand, in a second state, when the lighting of the ambient lighting unit 36 is turned off, the wood grain pattern WGP of the mirror plate 21 becomes difficult to be viewed, and it is possible to improve the visibility of the virtual image VI reflected and formed on the mirror plate 21.

The on and off states of the lights may be controlled by the control device 50. For example, when an operation switch provided on the steering wheel or the like is operated by the driver DRV and a signal is input to the control device 50, the control device 50 may switch between the first state and the second state by switching of the on and off states of the lighting.

Also, for example, the control device 50 may automatically switch the lighting between the on state and an off state based on the driving state of the vehicle 1. In more detail, the control device 50 may obtain information regarding the current automated driving level of the vehicle 1 from the vehicle 1, and switch between the first state and the second state based on the information. The level of automated driving is specified, for example, in SAE J3016. When the vehicle 1 is in a manual driving state (for example, a state corresponding to automated driving level 2 or lower), it is advisable to turn off the lighting to improve the visibility of the virtual image VI. When the vehicle 1 is in an automated driving state (for example, a state corresponding to automated driving level 3 or higher), the lighting may be turned on.

As another example of the function, the balancer layer 25a may apply a display function to the mirror plate 21 by using a display film material or sheet material having optical transparency for the balancer layer 25a. The display device 10 may include the ambient lighting unit 36 as the rear unit 31.

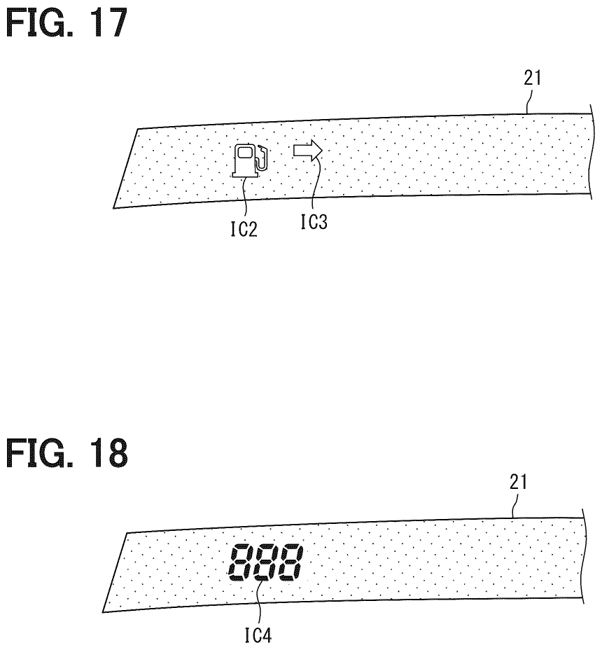

As shown in FIGS. 16 and 17, multiple icons IC1 to 3 are, for example, printed on the display film material. The light sources 37 of the ambient lighting unit 36 may be placed at positions directly behind the icons IC1 to IC3 so as to correspond to the icons IC1 to IC3 individually. The control device 50 may then individually switch between the on and off states of each light source 37 in conjunction with the state of the vehicle 1 to selectively display the multiple icons IC1 to IC3. The state of vehicle 1 here refers to, for example, whether an overtaking vehicle is approaching, the vehicle-to-vehicle distance, the air cleanliness, whether driver DRV is looking away from the vehicle, whether the driver DRV is dozing, and the like. The icon IC1 is a warning light for an approaching overtaking vehicle. The icon IC2 is a fuel level warning light. The icon IC3 is a turn signal light.

Further, as shown in FIG. 18, the icon IC4 is an 8-segment pattern for displaying, for example, a numerical value of the subject vehicle speed. By lighting the light sources 37 that individually correspond to each segment, characters such as numbers are displayed.

As another example of the function, a conductive film material, sheet material, or metal mesh having electromagnetic noise reduction performance is adopted for the balancer layer 25a. As a result, the balancer layer 25a may provide the mirror plate 21 with an electromagnetic noise reduction function, for example, by preventing the electromagnetic noise generated from the circuit board 12 or the like provided in the rear unit 31 from leaking outside the display device 10.

As another example of the function, a light-transmitting touch panel or a film-like FPC (Flexible Printed Circuits) having an antenna function is adopted in the balancer layer 25a. Thereby, the balancer layer 25a may provide the mirror plate 21 with a touch panel function. This enables the display device 10 to receive touch operations related to the content displayed on the display device 10, such as car navigation, entertainment, audio, and GPS.

As another example of the function, a moth-eye film material or sheet material, or an AR film material or sheet material having a reflection reducing property is adopted for the balancer layer 25a. Thereby, the balancer layer 25a may provide the mirror plate 21 with the function of reducing deterioration of appearance due to external light.

Further, the balancer layer 25a may be formed by laminating the above-mentioned film materials or sheet materials, thereby applying multiple functions to the mirror plate 21.

Furthermore, the balancer layer 25a may be configured by dividing the area formed by the surface of the balancer layer 25a into multiple division areas, and tiling different film materials or sheet materials for each of the divided areas. Thereby, the mirror plate 21 may have different functions for each division area.

### Other Embodiments

Although multiple embodiments have been described above, the present disclosure is not construed as being limited to those embodiments, and can be applied to various embodiments and combinations within a scope that does not depart from the spirit of the present disclosure.

Specifically, as a first modification, multiple mirror plates 21 may be provided so as to correspond to the image display units 11a to 11 c, respectively.

As a second modification, the number of image display units may be one.

As a third modification, the mirror plate 21 can have various shapes. The mirror plate 21 may be formed in a flat plate shape. The mirror plate 21 may be formed in a curved plate shape having a curved surface, such as a toroidal curved surface or a free curved surface.

As a fourth modification, the mirror plate 21 may have a light blocking property against all wavelengths of near-infrared light and visible light.

As a fifth modification, the optical function applied to the display optical component by the optical function-applying layer 23 may be a function other than the reflective function. The optical function-applying layer 23 may apply various optical functions shown as the functions of the balancer layer 25a in the third embodiment to the optical component for display.

In a sixth modification, the optical function-applying layer 23 may be made of a material that can be insert-molded and has a thin shape, such as metal, glass, inorganic material, organic material, synthetic resin material, or a composite material thereof. The optical function-applying layer 23 may further be configured such that painting, coating, or the like is applied to the surface or the interface with another layer.

As a seventh modification, the display optical component may be a windshield of a vehicle that reflects display light emitted from a head-up display device. The display optical component may be a combiner that reflects display light emitted from the head-up display device. The display optical component may be a decorative plate (decorative panel) provided on an in-vehicle display device.

As an eighth modification, the display optical components and the display device including the same do not have to be used in the vehicle 1, but may be used in consumer products such as televisions and smartphones, or digital signage.

The controller and the method thereof described in the present disclosure may be implemented by a dedicated computer, which includes a processor programmed to execute one or more functions performed by computer programs. Alternatively, the device and its method according to the present disclosure may be implemented by a dedicated hardware logic circuit. Alternatively, the device and its method according to the present disclosure may be implemented by one or more dedicated computers including a combination of a processor executing a computer program and one or more hardware logic circuits. The computer program may also be stored on a computer-readable and non-transitory tangible storage medium as an instruction executed by a computer.

What is claimed is:

1. A display device configured to perform display toward a viewer area, the device comprising:
a plurality of display units configured to emit display light; and
a display optical component that is provided for the plurality of display units and placed to direct the display light from each of the display units toward the viewer area, and has a plurality of layers in a lamination state,
wherein
a total numerical number of the display optical component provided for the plurality of display units is one, and
the plurality of layers include:
a base material layer;
an optical function-applying layer that has a thermal dimensional change characteristic that more easily contracts than the base material layer and applies an optical function to the display optical component;
a balancer layer that has a thermal dimensional change characteristic closer to the optical function-applying layer than the base material layer so as to balance stress with stress at a position close to the optical function-applying layer, wherein the balancer layer and the optical function-applying layer sandwich the base material layer; and
an additional adjustment layer laminated on a part of an area formed by a surface of the balancer layer and locally adjusts stress balance.

2. The display device according to claim 1, wherein
the display optical component is optically transparent.

3. The display device according to claim 1, wherein
the balancer layer is formed of a material different from a material of the optical function-applying layer, and has a thickness different from a thickness of the optical function-applying layer.

4. The display device according to claim 1, wherein
the balancer layer applies a function different from the function of the optical function-applying layer to the display optical component.

5. The display device according to claim 1, wherein
the optical function-applying layer applies a function of reflecting the display light as the optical function to form a virtual image close to a rear area that is opposite to the viewer area, and
the rear area and the viewer area sandwich the display optical component.

6. The display device according to claim 1, further comprising
a monitor unit placed in a rear area opposite to the viewer area, wherein the rear area and the viewer area sandwich the display optical component,
wherein
the monitor unit includes:
a camera that forms an image of light with a predetermined wavelength and captures the viewer area; and
a lighting device configured to emit light with the predetermined wavelength toward the viewer area and implements proper exposure in capturing, and
the balancer layer has wavelength selective transparency that selectively transmits light with the predetermined wavelength used by the camera and the lighting device.

7. The display device according to claim 1, further comprising
a rear unit that
is mounted in a vehicle including a plurality of seats and placed in a rear area opposite to a viewer area, wherein the rear area and the viewer area sandwich the display optical component, and
includes a rear unit that is different from the display unit and performs display from the rear area,
wherein
the display optical component has optical transparency, and
the optical function-applying layer applies a reflective function of the display light by the display unit as the optical function to form, in the rear area, a virtual image visible from a plurality of seats, and the balancer layer has a viewing angle control property or a polarization property to enable the display by the rear unit to be selectively visualized for a part of a predetermined seat among the plurality of seats.

8. A display device that is mounted in a vehicle including a plurality of seats and configured to perform display toward a viewer area, the display device comprising:
a plurality of display units configured to emit display light; and
a display optical component that is provided for the plurality of display units and placed to direct the display light from each of the display units toward the viewer area, and has a plurality of layers in a lamination state, wherein a total numerical number of the display optical component provided for the plurality of display units is one; and
a rear unit that
is placed in a rear area opposite to a viewer area, wherein the rear area and the viewer area sandwich the display optical component, and
includes a rear unit that is different from the display unit and performs display from the rear area,
wherein
the plurality of layers include:
a base material layer;
an optical function-applying layer that has a thermal dimensional change characteristic that more easily contracts than the base material layer and applies an optical function to the display optical component; and
a balancer layer that has a thermal dimensional change characteristic closer to the optical function-applying layer than the base material layer so as to balance stress with stress at a position close to the optical function-applying layer, wherein the balancer layer and the optical function-applying layer sandwich the base material layer,
the display optical component has optical transparency, and
the optical function-applying layer applies a reflective function of the display light by the display unit as the optical function to form a virtual image visible from a plurality of seats in the rear area, and the balancer layer has a viewing angle control property or a polarization property to enable the display by the rear unit to be selectively visualized for a part of a predetermined seat among the plurality of seats.

9. The display device according to claim 1, further comprising a lighting unit that is placed in a rear area opposite to a viewer area and provides a lighting effect from the rear area,
wherein
the rear area and the viewer area sandwich the display optical component,
the display optical component has optical transparency,
the balancer layer has a decorative pattern to be switchable between a first state and a second state,
in the first state and an on-state of the lighting unit, the decorative pattern is difficult to be viewed from the viewer area, and
in the second state and an off state of the lighting unit, the decorative pattern is viewable from the viewer area.

10. A display device configured to perform display toward a viewer position, the display device comprising:
a plurality of display units configured to emit display light;
a display optical component that is provided for the plurality of display units and placed to direct the display light from each of the display units toward the viewer position, and has a plurality of layers in a lamination state, wherein a total numerical number of the display optical component provided for the plurality of display units is one; and
a lighting unit that is placed in a rear area opposite to a viewer area and provides a lighting effect from the rear area,
wherein
the rear area and the viewer area sandwich the display optical component,
the plurality of layers include:
a base material layer;
an optical function-applying layer that has a thermal dimensional change characteristic that more easily contracts than the base material layer and applies an optical function to the display optical component; and
a balancer layer that has a thermal dimensional change characteristic closer to the optical function-applying layer than the base material layer so as to balance stress with stress at a position close to the optical function-applying layer, wherein the balancer layer and the optical function-applying layer sandwich the base material layer,
the display optical component has optical transparency,
the balancer layer has a decorative pattern to be switchable between a first state and a second state,
in the first state and an on-state of the lighting unit, the decorative pattern is difficult to be viewed from the viewer area, and
in the second state and an off state of the lighting unit, the decorative pattern is viewable from the viewer area.

11. A display optical component used for display, the display optical component comprising:
a plurality of layers in a lamination state,
the plurality of layers include:
a base material layer;
an optical function-applying layer that has a thermal dimensional change characteristic that more easily contracts than the base material layer and applies an optical function;
a balancer layer that has a thermal dimensional change characteristic closer to the optical function-applying layer than the base material layer so as to balance stress with stress at a position close to the optical function-applying layer, wherein the balancer layer and the optical function-applying layer sandwich the base material layer; and
an additional adjustment layer laminated on a part of an area formed by a surface of the balancer layer and locally adjusts stress balance.

12. The display optical component according to claim 11, wherein the plurality of layers have optical transparency in a lamination state.
